(19) United States
(12) Patent Application Publication
(10) Pub. No.: US 2007/0143006 A1
(43) Pub. Date: Jun. 21, 2007

(54) Transponder-assisted positioning system

(75) Inventor: Andreas Plettner, Berg (DE)

Correspondence Address: NIXON PEABODY, LLP, 401 9TH STREET, NW, SUITE 900, WASHINGTON, DC, 20004-2128, US

(73) Assignee: INDYON GMBH, Muenchen (DE)

(21) Appl. No.: 10/572,380

(22) PCT Filed: Sep. 14, 2004
(86) PCT No.: PCT/EP04/10273

§ 371 Date: Jan. 19, 2007

(30) Foreign Application Priority Data
Sep. 16, 2003 (DE) 103 42 767.8

(51) Int. Cl. G01C 21/00; G08G 1/123

(52) U.S. Cl. 701/207; 340/988

(57) ABSTRACT

System for the vehicle-assisted storing and removal of goods in a warehouse with automatic position determination of at least the stored goods, comprising a plurality of transponder devices that are placed in the floor of the warehouse in a distributed manner. Each transponder device stores information that represents, at least indirectly, the position of the corresponding transponder devices inside the warehouse. The inventive system also comprises a vehicle for transporting goods to be stored and removed, a reading device, which is mounted on the vehicle while automatically reading out information from transponders driven over by the vehicle, and a computer device, which receives the information read out from the transponders by the reading device, and which from this information, determines and stores at least the position at which the goods are stored inside the warehouse.

The invention relates to a transponder-assisted positioning system and particularly to a system for the vehicle-assisted storing and removal of goods in a warehouse with automatic position determination of the stored goods as well as an appropriate method and a suitable vehicle for the same.

In order to ensure optimisation of storage and automatic tracking of goods in a warehouse, it is necessary to control the storing and removal processes of transport vehicles exactly for position in a storage area. Thus, stock in hand can be guaranteed at any time.

In outdoor stores appropriate goods tracking systems can be realised by using a satellite-assisted positioning system (GPS) with a differential GPS system. However, since GPS can only be used outdoors, this type of goods tracking system cannot be used in indoor warehouses. In this respect so-called indoor navigation systems are required, which also facilitate positionally accurate tracking of transport vehicles during warehouse storing and removal processes in warehouses. The location of transport vehicles, such as for example fork-lift trucks, within enclosed or covered warehouses facilitates the automatic management of goods that are transported or to be transported.

DE-C1-199 38 345 describes a method and a device for the acquisition of the position of a vehicle in a specified area, in particular a storage facility as well as a stores management method and system. The acquisition of the vehicle position is essentially based on two measurements—an incremental measurement of the wheel angle of rotation, which provides information about the distance travelled and thus about a relative change of position, as well as an optical measurement of the absolute position via reference points on the warehouse roof which are optically sampled. As reference points, special strip arrangements are fitted to the warehouse roof, which permit a computation of the position and the angle to be made on being swept by the laser beam. Thus, errors in the position determination through the incremental measurement of the wheel angle of rotation can be compensated and corrected. However, this technology has disadvantages with regard to the precision of the change of position of the transport vehicle, because there are special difficulties in that slippage and drift, which can arise over a travelled distance, must be compensated. Furthermore, the mechanical sensing of the distance by the wheel is susceptible to dust, films of lubrication, soot, etc. Moreover, a disadvantage of this technology are the costs incurred.

The difficulties in the determination of the precision of the positional change can lead to the device described above being unable to be used in many cases, because the accuracy demanded in a warehouse management system cannot be achieved with it or the costs are too high. Generally, in normal warehouse management systems accuracies of smaller than 40 cm are needed. This requirement results from the fact that it must be possible to differentiate two adjacent storage places in a storage area from one another, in which objects or goods are stored, for example on pallets, wherein the accuracy of the storage or removal position must be known to at least one half the width of a pallet.

A further problem with regard to the required accuracy is that various storage areas usually exhibit different structures, because storage areas are often enlarged through extensions and generally consist of a number of storage rooms which may have different ground plans and heights. In these types of structures warehouse aisles may have lengths of over fifty meters. Furthermore, theses types of warehouse aisles can be realised small and also be used for the deposition of goods or objects directly in these sorts of aisles when no other storage places are free. In particular in long and narrow warehouse aisles transport vehicles travelling round sharp bends must be avoided. Therefore the required accuracy for the position determination in a warehouse management system is an important factor which must be taken into account.

The object of the invention is to provide a possibility of enabling a simple and precise position determination of goods at the time of storing in a warehouse.

This object is solved according to the invention by the subject matter of claims 1, 15 and 16.

Preferred embodiments form the subject matter of the dependent claims.

The invention is in particular based on the knowledge that systems, in which the position of goods to be stored is found in that the transporting vehicle acquires the distance travelled via wheel sensors, are too inaccurate or too susceptible to faults. Furthermore, the invention is based on the knowledge that previously known systems, in which each goods item bears a transponder are, at least at the current point in time, too expensive and moreover these transponders can only be read when a reading device is brought into the vicinity of the stored goods. This means that these types of systems are not suitable for use within the scope of efficient goods tracking.

According to the invention transponders, which when driven over by the transport vehicle provide information about the current position of the transport vehicle and thus also the transported goods, are mounted on the floor spaced at specified distances, at least over the most travelled part of a warehouse. This tracking lasts until the goods are actually stored so that the final position at which the goods have been stored can be acquired. If these data are combined with data which describe the goods, then this offers a basis for an efficient goods tracking system.

Preferred embodiments of the invention are explained below in more detail with reference to the enclosed drawings. Here, the drawings show:

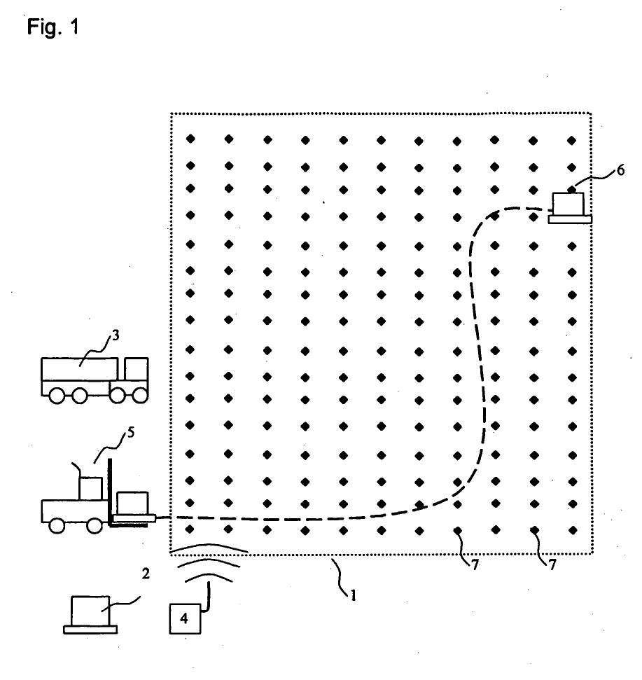

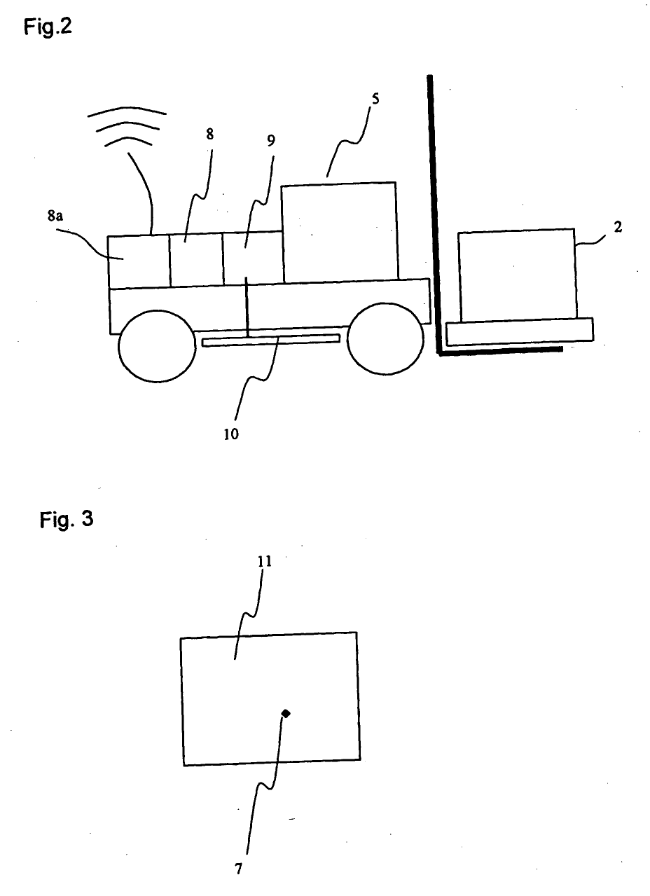

FIG. 1 shows a schematic view of a warehouse to illustrate the functioning principle of a preferred embodiment of the invention;

FIG. 2 shows a schematic representation of a transport vehicle needed for the preferred embodiment;

FIG. 3 shows a schematic representation of a transponder which is swept by an antenna field and

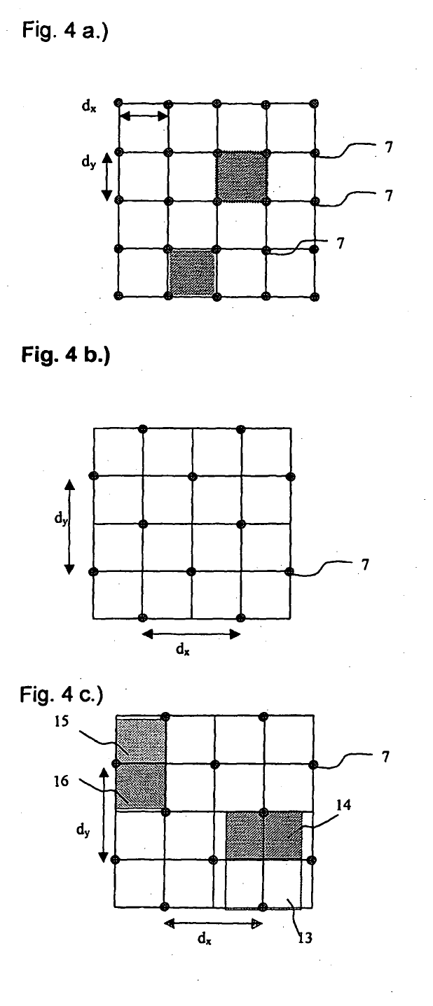

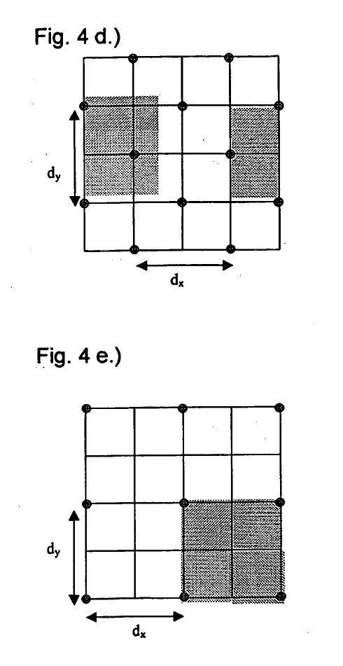

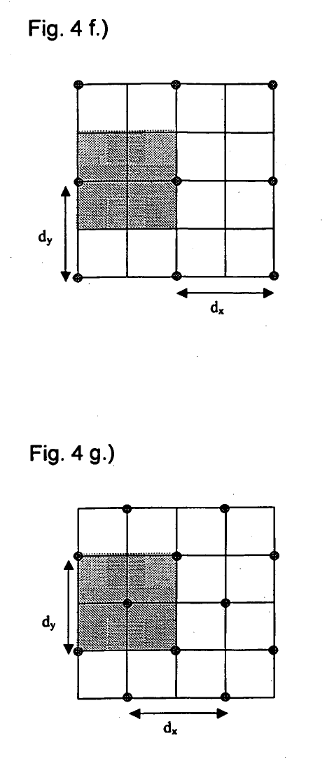

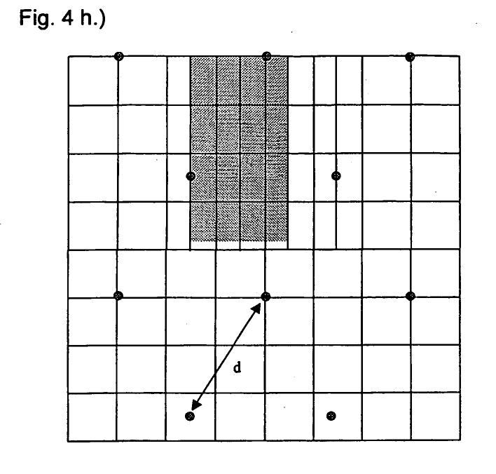

FIGS. 4a-4h show schematic representations of different versions of how the antenna field can be selected with regard to the transponder distribution.

FIG. 1 shows a schematic view of a warehouse 1 in which goods are stored and from which goods are removed. A goods item 2, which for example is delivered by a truck 3, preferably bears a bar code, which facilitates the automatic detection and saving of the identity and/or the type of goods by a warehouse computer device 4 via a suitable reading device. For storing, the goods item 2 is taken up by a vehicle, preferably a fork-lift truck 5 and conveyed to a suitable position 6 within the warehouse. A suitable route from the warehouse entrance to the position 6 is marked with dashes. On the route of the fork-lift truck 5 to the storage position 6 a reading device mounted on the vehicle 5 sweeps a number of transponders 7 which are arranged distributed over the floor of the warehouse. The transponders 7 are preferably recessed in small holes in the warehouse floor and can therefore be driven over without any problem. The reading device on the vehicle 5 comprises at least one aerial which defines an appropriate aerial array. When the aerial array of the reading device is moved over one of the transponders 7, information is read out of the transponder. This information defines at least in an indirect manner the position of the corresponding transport device within the warehouse 1, so that each time when this type of information is read out, the current position of the vehicle 5 can be determined. Thus, on the route from the warehouse entrance to the storage position 6 a number of these types of position determinations are carried out, each time when a transponder is driven over. Finally, this results in the exact storage position being automatically known at the time of storage of the goods item 2 at the position 6. The various intervening position determinations can be temporarily saved in a computer device, which is not shown and which is located on the vehicle 5 or they can be transmitted by radio to a stationary computer device 4 for further processing.

Basically, just to determine the storage position it is only necessary to identify the storage positions and not the routes travelled. The documentation of the routes travelled or the knowledge of the current position can also be included for navigational support and for statistical purposes (e.g. average duration as a function of the distance travelled for storing).

Not each of the transponders 7 needs to be a high quality transponder which is able to provide information about the position of these transponders. Instead transponders can also be used amongst them which only act as markers, i.e. they are only detected when driven over. These markers provide orientation between two actual position determinations and are so to speak counted on being driven over. In this way it is possible to keep the distances between the transponders short and, despite this, to maintain the total costs at a reasonable level, because the transponders which only act as markers are substantially less expensive.

Of course, it must be taken into account that at the time of depositing the goods item 2 at the position 6 the storage position has an offset compared to the vehicle position, because the vehicle places the goods item into a suitable rack. This distance is either always the same and can therefore be added or it is measured using a special distance sensor. This is especially necessary when the vehicle is realised as a fork-lift truck and is able to store goods items or pallets at different levels in the rack.

There is preferably also on the vehicle 5 a device which can determine the storage height so that finally the x, y and z co-ordinates for the storage position can be acquired. All these data are saved in a computer device on the vehicle or are continuously transmitted by radio to the computer device 4.

The final position of a stored goods item is detected in that the driver of the vehicle presses a certain key with which storing is acknowledged and thus the end of the transport is indicated. Of course, this can also occur automatically in that a deposition sensor on the vehicle is present which automatically detects the deposition of the goods item. Of course, other solutions are also possible, for example, various types of sensors which are located in the racks and thus the time of storage is detected via this type of sensor.

If the transponders 7 do not save all position data, but rather partially act only as markers which are counted, then this type of embodiment can be combined with sensors on the vehicle 5 which acquire the vehicle distance travelled via wheel revolutions. Thus the intervening position between two actual position determinations can be very accurately estimated using the markers and the wheel sensors.

FIG. 2 shows the vehicle 5 which is preferably a fork-lift truck. This fork-lift truck preferably comprises a computer device 8 which is coupled to a reading device 9. This reading device comprises at least one aerial 10, which defines an aerial array that is arranged on the underside of the fork-lift truck and detects and reads out the transponders which are driven over. The read-out information is temporarily saved in the computer device 8 and transmitted to a stationary computer or server device at regular intervals or continuously by means of a radio modem 8a.

FIG. 3 illustrates an aerial array 11 defined by the aerial 10 in FIG. 2 and which is just sweeping a transponder 7. As long as the aerial array 13 is located above the transponder the information stored in the transponders, preferably positional information, can be read out.

FIGS. 4a-4h show different embodiments of the aerial arrays.

In particular it is possible to define many aerial arrays, which can also overlap, by means of many aerials. A number of aerial arrays have the advantage that a directional determination in addition to the momentary position is possible via the temporal sequence of sweeping different or identical transponders. The same applies to overlapping areas of the aerial arrays. The detection of a transponder in an overlapping area similarly facilitates the refinement of the momentary position determination.

If operation occurs with one single aerial array, then the resolution of the position determination is essentially defined by the transponder spacing with respect to one another.

The advantage of the use of a number of aerial arrays is that refinement of the position determination is facilitated despite the same transponder spacing.

FIG. 4a illustrates the case in which an aerial array 12 is formed by a single aerial. Here, two variants are possible, one being that the aerial array is smaller than the area between adjacent transponders, which means that the aerial array can always only sweep one transponder at any one time.

In the other case the aerial array is larger than the corresponding area so that a number of transponders can be read out simultaneously.

FIG. 4b shows another pattern of arranging the transponders 7. This pattern corresponds to a square or rectangle with a transponder at each of the corners and in the centre.

FIG. 4c shows a case in which the aerial array is formed in each case by two subfields 13, 14, respectively 15 and 16.

With the case shown on the left (subfields 15, 16) for which applies:

$${a}_{x} = \frac{1}{2} {d}_{x} ⋀ {a}_{y} <= \frac{1}{2} {d}_{y}$$

the situation can occur in which no transponder is read. This information can however also be interpreted, because the direction can be found from the previous measurements and up to shortly before reaching this position the other transponders can be read. The position can therefore be unambiguously determined.

There is a tolerance t in each of the x and y directions:

$${t}_{x} = \frac{1}{2} {d}_{x}$$

$${t}_{y} = \frac{1}{2} {d}_{y}$$

For the case on the right, for which the following applies:

$${a}_{x} = \frac{3}{4} {d}_{x} ⋀ {a}_{y} \geq \frac{1}{2} {d}_{y}$$

the situation can arise in which a reading field simultaneously covers two transponders and consequently no information can be read (incorrect read). This situation can however also be interpreted, because the direction can be found from the previous measurements and up to shortly before reaching this position the other transponders can be read. The position can therefore be unambiguously determined. Of course, also transponder systems can be used in which one aerial can detect two or more transponders simultaneously.

There is a tolerance t in each of the x and y directions:

$${t}_{x} = \frac{1}{4} {d}_{x}$$

$${t}_{y} = \frac{1}{2} {d}_{y}$$

FIG. 4d shows a case in which the reading fields each overlap by half their length. Preferably, the single fields in the y direction are each extended by one third, so that with each aerial array two thirds are not overlapped and one third is overlapped, producing a ratio between areas not overlapped and overlapped areas of 2:1.

According to the case on the left, an extension of the aerial arrays by one third in the x direction can also occur.

With the illustrated case an “incorrect read” would be produced for each aerial, which can be appropriately interpreted, therefore permitting an unambiguous position determination. As indicated, transponder systems can also be used in which two or more transponders can be read simultaneously. In this case the data from the previous measurement is only required to determine the orientation.

$${a}_{x} = \frac{3}{4} {d}_{x} ⋀ {a}_{y} \frac{2}{3} {d}_{y} , overlapping = \frac{1}{3} {d}_{y} ,$$

where aₓ, a_{y} indicate the extension of the aerial array.

There is therefore a tolerance t in each of the x and y directions:

$${t}_{x} = \frac{1}{4} {d}_{x}$$

$${t}_{y} = \frac{1}{3} {d}_{y}$$

By shortening the field in the y direction to values below the transponder spacing the “incorrect read” becomes “no read”, and this can be appropriately interpreted.

$${a}_{x} = \frac{1}{2} {d}_{x} ⋀ {a}_{y} = \frac{2}{3} {d}_{y} , overlapping = \frac{1}{3} {d}_{y}$$

There is therefore a tolerance t in each of the x and y directions of:

$${t}_{x} = \frac{1}{2} {d}_{x}$$

$${t}_{y} = \frac{1}{3} {d}_{y}$$

FIG. 4e shows four aerials which are arranged as a square or rectangle.

In this case it is intended that each aerial can read a maximum of one transponder. The fields of the aerials overlap at the contacting edges only so far that a transponder, which is located directly under a centre line, is acquired by both adjacent aerial arrays. Each aerial array is the same as one field with half a transponder spacing and all transponders located at the edges are located in the reading field.

$${a}_{x} = \frac{1}{2} {d}_{x} ⋀ {a}_{y} = \frac{1}{2} {d}_{y} , overlapping = 0$$

There is a tolerance t in each of the x and y directions:

$${t}_{x} = \frac{1}{2} {d}_{x}$$

$${t}_{y} = \frac{1}{2} {d}_{y}$$

FIG. 4f again shows four aerials as a square. One aerial can read a maximum of one transponder. The fields of the aerials overlap at the contacting edges by 50% (in that each aerial array is enlarged by 4/3 compared to the variant according to FIG. 4e). Each aerial array is the same with one field with half a transponder spacing and all transponders located at the edges are located in the reading field.

$${a}_{x} = \frac{2}{3} {d}_{x} \hat{} {a}_{y} \frac{2}{3} {d}_{y} , overlapping = 50 \%$$

There is a tolerance t in each of the x and y directions of:

$$\begin{matrix}{t}_{x} = \frac{1}{3} {d}_{x} \\ {t}_{y} = \frac{1}{3} {d}_{y}\end{matrix}$$

With FIG. 4g the aerials are arranged as in FIG. 4f, but, in contrast to this case, another transponder is located in the centre point of each square. The aerial arrays overlap as in the FIG. 4f. The accuracy can be increased with this arrangement.

$${a}_{x} = \frac{2}{3} {d}_{x} \hat{} {a}_{y} = \frac{2}{3} {d}_{y} , overlapping = 50 \%$$

There are tolerances t in each of the x and y directions of:

$$\begin{matrix}{t}_{x} = \frac{1}{6} {d}_{x} \\ {t}_{y} = \frac{1}{6} {d}_{y}\end{matrix}$$

With the arrangement according to FIG. 4h the spacings of all adjacent transponders are chosen to be equidistant. This produces a hexagonal arrangement. With the illustrated variant the two aerial arrays overlap again in the y direction.

It can be generally said with the variants described above that these reading devices can be used which can read a number of transponders simultaneously in one aerial array. It is also possible to take aerial arrays which can only read one transponder at any one time and which then produce an “incorrect read” on being swept by two transponders simultaneously. This “incorrect read” is however also acceptable information so that in this case three different states can be obtained which contribute to more accurate position determination or facilitate the detection of the travel direction.

The above described tolerances play a corresponding role with regard to the accuracy with which the goods item can be deposited and therefore also retrieved again.

Through the continual reading in of new positional data through to the final storage, a movement history can be produced which permits the movement direction and orientation of the fork-lift truck to be acquired during storing and removal. Similarly, the determination of the speed and acceleration of the vehicle is possible as a result. Furthermore, the data permits statistical statements to be made which allow statements to be made about the distance travelled and about temporal sequences. For example, a statement is possible about how long it takes to off-load a certain truck and to deposit the goods at the required positions. Also it can be predicted when the vehicle or the fork-lift truck will arrive at a certain warehouse position. Furthermore, the continually recorded positional data can be used to control the direction of travel for the vehicle or the fork-lift truck in real time.

Although, as described above, the position determination accuracy can be increased in that a number of, in particular overlapping, aerial arrays are used and therefore better positional details can be obtained than if the accuracy were to only depend on the transponder spacing, there is a residual error tolerance with regard to the position determination. According to the invention, this resulting tolerance can however be determined absolutely and does not depend on the distance the fork-lift truck has travelled, as is the case, when the fork-lift truck position is determined by wheel sensors.

In order to retrieve a goods item unambiguously the tolerance t must be smaller than half the article size:

$${t}_{x} = \frac{1}{2} {w}_{x} \hat{} {t}_{y} < \frac{2}{2} {w}_{y}$$

where t is the tolerance and w is the dimension in the x and y directions of the goods item/pallet to be stored.

For the removal of the goods item the stored position of the goods item is read out from the system. This positional information can now be used to guide the fork-lift truck to the correct position either fully automatically or by providing the directional information.

Generally, devices are preferably provided which enable the system to know which goods item is to be stored. This can preferably occur in that a bar code is located on the goods item which is read before storing. It is also possible that the goods item is already known from a production planning and control system (PPC) and these data are accepted on transfer to the fork-lift truck.

Of course, it is however also possible that a driver of the fork-lift truck is provided with the position and then drives the fork-lift truck to the appropriate location.

A decisive advantage with the invention is however that the sought goods item is located with certainty at the correct position, because the deposition of the goods item has defined this position. In particular, goods do not need to be deposited according to a certain distribution scheme, but rather can be deposited as required and rearranged many times without problem. After reaching a new position, the system is informed of the final position in that the deposition causes the saving of the final position in conjunction with the data which describe the goods item.

The system can also be combined with variants in which the goods themselves carry transponders. This variant is particularly advantageous, because here when the goods item is taken up it automatically identifies itself to the computer located on the vehicle and is therefore inevitably correctly acquired. Then the route travelled with this goods item is tracked and logged due to continually driving over transponders. Finally, the position is saved at which this corresponding goods item is deposited. As indicated already above, the system according to the invention can be advantageously employed despite the use of transponders on the goods, because a complete distribution plan of the corresponding goods in the warehouse can be produced. Without the system according to the invention the deposited goods would be able to be identified, but only then when they are moved directly to the appropriate location with a reading device.

Preferably, the computer provided on the vehicle is able to save appropriate positional data over a longer period of time. This is advantageous for the case when the radio link to the server is interrupted. Alternatively, the intermediate storage allows for the possibility that no radio system is provided, but rather that the vehicle or fork-lift truck occasionally transfers its data to the server via a cable. This variant results in very cost-effective systems. For the wireless communication between the vehicle and the server preferably a radio LAN is provided.

Of course, the transponder spacing can be denser where the goods are normally actually deposited. In free areas which are only driven over, the spacing can be significantly larger, because here a momentary position acquisition is less important. It is decisive that the deposition of the goods at the storage position is correctly acquired.

Also the taking up of goods from storage is preferably already acquired in the system by sensors such that the stock in hand is always correctly acquired. It is thus possible not only to know where the goods are located, but rather it is also ensured that the exact stock in hand can be recalled.

As already mentioned, the precise off-loading time for a delivering truck or the loading time can be predicted from the additional data such as speed, etc., which can be derived from the position acquisition. The system can precalculate that a certain loading will take longer, because long distances must be travelled for removing the goods from storage. This is even possible when the goods to be loaded are positioned at completely different locations in the warehouse. The system can precalculate the retrieval time for each single goods item.

To acquire the z co-ordinate for the deposition of the goods item in a high bay warehouse the fork-lift truck preferably has appropriate sensors which, during the deposition of the goods item, acquire the height at which the fork-lift truck has deposited the goods item. Furthermore, as already explained, also the distance of the deposited goods item to the fork-lift truck is acquired in order to correctly acquire the corresponding offset during the position determination.

1. System for the vehicle-assisted storing and removal of goods in a warehouse with automatic position determination of at least the stored goods, with:
a large number of transponder devices fitted to the floor of the warehouse in a distributed manner, wherein each transponder device stores information, which at least represents indirectly the position of the corresponding transponder device within the warehouse,
a vehicle for transporting goods to be stored and removed,
a reading device fitted to the vehicle for the automatic reading out of information from transponders which the vehicle drives over,
a computer device, which receives the information read out from the transponders by the reading device and determines and saves from this at least the position at which the goods item is stored within the warehouse.

2. System according to claim 1, characterised in that the position determination of a goods item to be stored is carried out a number of times during transport by the vehicle through to the final storage position by driving over various transponder devices.

3. System according to claim 1, characterised in that some of the transponder devices contain no positional information, but rather are only detected by the reading device when driven over and thus an auxiliary position determination is facilitated until the next genuine position determination.

4. System according to claim 1, characterised in that the computer device comprises at least one first computer device installed on the vehicle, which is coupled to the reading device, and a second stationary computer device, which communicates with the first computer device by radio.

5. System according to claim 4, characterised in that the first computer device is a PC and the second computer device is a server.

6. System according to claim 1, characterised in that the vehicle is a fork-lift truck.

7. System according to claim 1, characterised in that the reading device comprises at least one aerial, which defines a predetermined aerial array, wherein the reading out of a transponder device by sweeping the transponder device with the aerial array occurs.

8. System according to claim 1, characterised in that the final position determination when storing is calculated via the momentary reference position of the vehicle and an offset distance, which corresponds to the distance of the goods item being stored from the reference position of the delivering vehicle.

9. System according to claim 1, characterised in that the final position determination during storing occurs in response to a signal which is given by the driver of the vehicle or is provided by a sensor which detects the deposition of the goods item.

10. System according to claim 1, characterised in that the goods item to be stored is automatically acquired on delivery by a reading device and these data describing the goods item are combined with the storage position by the computer device.

11. System according to claim 1, characterised in that a device is provided which also acquires a quantity at the time the goods item is stored which represents the distance of the goods item from the floor, so that a position determination in x′, y′ and z′ with respect to the axis is possible.

12. System according to claim 1, characterised in that the reading device comprises a plurality of aerials.

13. System according to claim 12, characterised in that the plurality of aerial arrays at least partially overlap.

14. System according to claim 1, characterised in that the aerial array sweeps more than one transponder simultaneously.

15. Method for the vehicle-assisted storing and removal of goods in a warehouse with automatic position determination of at least the stored goods, comprising the steps:
fitting of a large number of transponder devices to the floor of the warehouse in a distributed manner, wherein each transponder device stores information, which at least represents indirectly the position of the corresponding transponder device within the warehouse,
driving over the transponder devices with a vehicle containing a reading device, which reads out the information from transponder devices which the vehicle drives over,
saving all read-out data up to the point at which the goods item is deposited in the warehouse,
determination of the storage position of the goods item based on the information read out of the transponder devices, and
saving of the final storage position of the goods item in a computer device.

16. Vehicle for the storing and removal of goods in a warehouse with automatic position determination with regard to the stored goods, with:
a reading device for the automatic read-out of information from transponder devices which are distributed on the floor of the warehouse and which the vehicle drives over,
a computer device, which receives the information read out from the transponders by the reading device and determines and saves from this at least the position at which the goods item is stored within the warehouse.

17. Vehicle according to claim 16, characterised in that the vehicle has a transmitting device at its disposition, by means of which obtained positional data can be transmitted in a wireless manner to a server device.
